(19) United States
(12) Patent Application Publication
(10) Pub. No.: US 2012/0166334 A1
(43) Pub. Date: Jun. 28, 2012

(54) METHODS AND SYSTEMS FOR IDENTITY BASED TRANSACTIONS

(76) Inventors: Debbie Kimberg, Chesterfield, MO (US); Shawn Hagmeier, St. Peters, MO (US)

(21) Appl. No.: 12/978,226

(22) Filed: Dec. 23, 2010

(51) Int. Cl. G06Q 20/00

(52) U.S. Cl. 705/44

(57) ABSTRACT

Pursuant to some embodiments, methods, systems, apparatus, computer program code and means for conducting a transaction by a user are provided that include receiving, during a purchase transaction, transaction data and a unique user identity identifier associated with a payment card; providing the identity identifier and the transaction data to a payment network; requesting verification of the transaction data and identity identifier; receiving a reply to the verification request of the transaction data and the identity identifier; associating a payment account number with the identity identifier; and authorizing the purchase transaction based on the payment account number associated with the identity identifier.

### FIELD

The present invention relates to payment accounts and products. In particular, the present invention relates to systems and methods for facilitating the use of an identity of a cardholder in secure transactions.

### BACKGROUND

Payment cards including credit and debit cards are widely accepted and used by consumer cardholders and merchants. Payment cards each have an account number associated with the card. In cards having a magnetic stripe, the account number is encoded in the magnetic stripe. In other cards having an integrated circuit (IC) chip and memory, the account number is stored in the memory and may be communicated to a point of sale (POS) terminal using contact or contactless technology. The account number communicated to a merchant as part of a purchase transaction provides a mechanism for card holders to conveniently and easily make purchases using their payment cards.

Providing payment cards and their corresponding account numbers to each and every merchant, service provider, and company in order to enjoy the convenience of using the payment cards may leave a cardholder exposed to more risk of potential credit fraud than desired. Recognizing this concern, industry standards such as those provided by Payment Card Industry (PCI) have been developed to provide guidance and safeguards concerning the gathering, storing, and processing of payment card account information. However, being PCI compliant to provide a secure and protective environment for payment card transactions requires resources. Furthermore, merchants are at risk of financial and/or reputational damage should their security systems become hacked and stored account information is compromised.

It would be desirable to provide efficient and convenient methods and systems to conduct payment card transactions where the card's account number is not exposed to accepting merchants and processors.

### BRIEF DESCRIPTION OF THE DRAWINGS

FIG. 1 is a block diagram depicting a payment system according to some embodiments.

FIG. 2 is a flow diagram according to some embodiments.

FIG. 3 is a block diagram depicting a payment system according to some embodiments.

FIG. 4 is a tabular representation of a portion of a database according to some embodiments.

FIG. 5 is a tabular representation of a portion of a transaction database according to some embodiments.

FIG. 6 is a block diagram of a payment provider device according to some embodiments.

### DESCRIPTION

Embodiments of the present invention relate to systems, methods, processes, computer program code, and means for using payment cards to conduct transactions over a network. In some embodiments, the physical payment card can be a credit, debit or stored value card, and may be a magnetic stripe, contactless chip, or contact chip payment card.

Embodiments of the present invention relate to a purchase transaction that occurs between a payment cardholder and a merchant, or more generally a seller, once the cardholder has selected one or more items to purchase. In particular, processing, in some embodiments, begins when the customer chooses to check out and purchase goods and/or services using a new payment option referred to herein as an “Identity Payment”. However, prior to the cardholder and the merchant engaging in a purchase transaction as discussed in greater detail below, the cardholder enrolls or registers in an “Identity Payment” service. Enrollment in the “Identity Payment” service may involve the cardholder providing a unique and personal identity identifier. The unique identifier may conveniently be the user's mobile phone number. However, other unique and personal identifiers may be used, such as bioidentity identifiers and other identifying mechanisms. (Those skilled in the art will recognize that the term “Identity Payment” is used simply as an illustrative example, other brand names or terms may be used).

Other cardholder contact information such as the cardholder's name, home address, personal identification number (PIN), and other background information may also be requested as part of the enrollment or registration process. Such background information may be requested to ensure compliance with know your customer (KYC) and other policies and other applicable security and/or due diligence regulations.

Furthermore, the cardholder may provide a listing of the one or more cards they wish to use to make payments using the “Identity Payment” service. Each of the one or more cards and accounts included in the “Identity Payment” service are associated with or linked to the cardholder's unique and personal identity identifier (e.g., the user's mobile phone number). In some embodiments, credit cards, charge cards, debit cards, and demand deposit accounts may be registered with the “Identity Payment” service. In some embodiments, other types of accounts such as prepaid cards, gift cards, reward cards, stored value cards, and department store cards may also be included for registration or enrollment.

In an aspect of the “Identity Payment” service, the cardholder may provide an alias for each of the cards or accounts in the service or program. An alias may be a name that is easily recognizable and remembered by the cardholder. For example, a cardholder including two credit cards and a debit card in their enrollment in the “Identity Payment” service may differentiate the credit cards by providing the alias “Everyday” for the credit card to be typically used for routine daily purchases and the alias “Special” for the credit card that may be used sparingly for major purchases.

In an embodiment herein, a cardholder may selectively include one or more controls on the cards or accounts they have registered with the “Identity Payment” program. For example, the cardholder may indicate a card in the “Identity Payment” service may be used for or prohibited from being used for certain categories of goods and services, the card has a self-imposed spending limit (i.e., distinct from a credit limit imposed by a card issuer) that may be based on a length of time and/or frequency of usage, and other controls.

In some embodiments, a cardholder may designate one card as a “default” use card. That is, the “default” card is used unless the cardholder specifies the use of another one of their cards or accounts linked to their identity (e.g., mobile phone number) in the “Identity Payment” service.

In some embodiments, a credit card issuer or their agent may register credit card, debit card, prepaid card, and other account numbers with the “Identity Payment” service. The credit card, debit card, prepaid card, and other account numbers may be registered with the “Identity Payment” service before or as these cards are issued to cardholders. Registering the credit card, debit card, prepaid card, and other types of account numbers with the “Identity Payment” service and systems herein by the issuer may entail at least tracking the card or account numbers of the issued cards and the mobile phone number of the cardholder to whom the cards are issued. In an embodiment where the issuer registers cards in the “Identity Payment” service, the initial enrollment may just include cards issued by that particular issuer. However, a cardholder linked to, responsible for, or otherwise associated with an issued card registered with the “Identity Payment” service by any issuer may later add or link other cards and/or accounts to their mobile phone number or other identity identifier. In some embodiments, the issuer may add, update, and modify cards and accounts associated with an “identity” at any time based on the identifier.

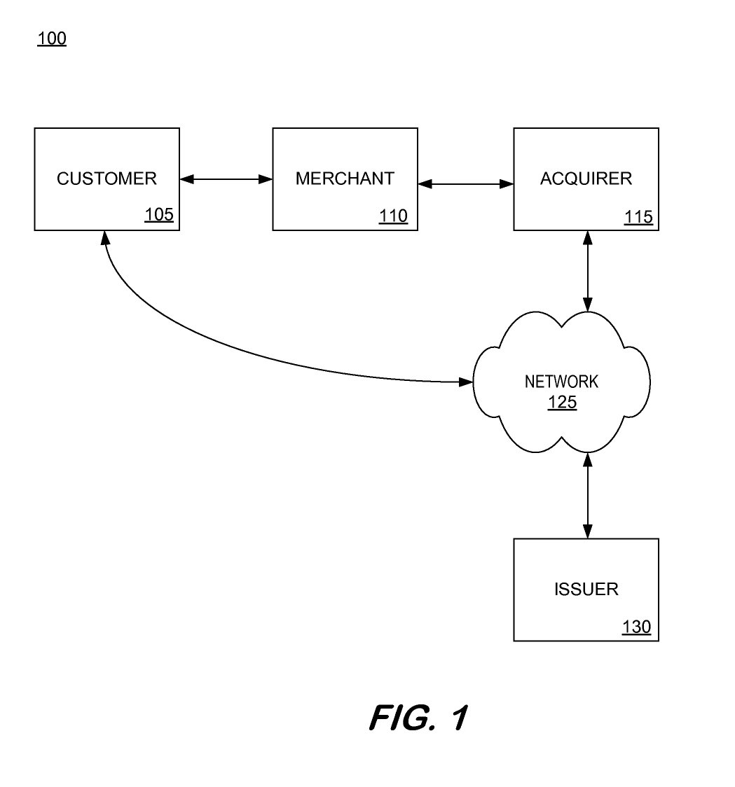

Features of some embodiments of the present invention will be described with reference to FIG. 1 that depicts a block diagram of a system 100 pursuant to some embodiments. FIG. 1 illustrates a system in accordance with aspects herein to facilitate a cardholder or user 105 making a purchase of goods and/or services from a merchant seller 110 using a payment card as a means of paying for the transaction. Cardholder 105 may provide payment card data to a merchant 110 by presenting the payment card for payment. In some embodiments, the payment card data includes a unique and personal “identity” identifier that is specifically associated with the cardholder. In one embodiment, the unique and personal identifier is the cardholder's mobile phone number. The mobile phone number of the cardholder is well-suited for being a unique and personal identifier since the cardholder's mobile phone number is strictly associated with a particular device (e.g., a mobile phone) owned by the cardholder and the phone number is unique (e.g., area code+seven digit number).

According to some embodiments, merchant 110 may receive the cardholder's phone number or other identity identifier presented with the payment card in accordance with the present disclosure in a number of different manners. In one aspect, merchant 110 may receive the cardholder's unique identity identifier by typing the cardholder's recited phone number into a system or device using a keyboard or keypad at the point of sale (POS). In some other embodiments herein, the payment card of cardholder 105 may have a magnetic stripe. As is known, the data encoded in the magnetic stripe may include a variety of payment data. In accord with the present disclosure, the payment data includes the user's mobile phone number. In yet another embodiment, the payment card presented to merchant 110 by cardholder 105 may include a NFC (near field communication) device such as, for example a card having an embedded RFID chip or a suitably configured device (e.g., smartphone). Also, the cardholder's unique identifier may be conveyed to merchant 110 by swiping a sticker or other indicia that is affixed in or on the payment card.

It is noted that while the payment card data may be provided to merchant 110 and received by merchant 110 in a variety of different ways, the data provided to merchant includes the cardholder's mobile phone number (or other designated personal, unique identity identifier) but not the actual account number for the payment card.

In some embodiments, the unique identity identifier may be encoded on the magnetic stripe of a payment card and readable by a card reader. In some aspects, the identity identifier may be provided to a merchant seller while the actual account number is not provided to the merchant seller. In one embodiment, the identity identifier may be provided to the merchant in the “clear” (i.e., not encrypted), whereas the account number is encrypted.

In some embodiments, cardholder 105 may present the mobile phone number to merchant 110 for payment either in person or online over a network such as the Internet (not shown). In either scenario, the cardholder's phone number is provided for payment of a transaction, whereas the account number is not provided to merchant 110. In this manner, merchant 110 does not receive the user's account number. Accordingly, the merchant may be relieved of some of the regulatory compliance requirements associated with the handling of payment card account numbers.

Merchant 110 proceeds to provide the transaction data comprising the cardholder's unique and personal identity identifier (e.g., mobile phone number) and transaction purchase details to a network 125 either directly or via acquirer 115. In some aspects, functions of acquirer 115 may be accomplished by a third party processor. The acquirer 115 may, in some embodiments, facilitate the merchant communicating the transaction data to network 125. The transaction data may further include merchant/acquirer information to accurately track the transaction for settlement purposes and full receipt line item details.

Network 125 contacts cardholder 105 at the mobile phone number linked to the “identity” presented to merchant 110 for payment. The cardholder is requested to verify or accept the details of the transaction and verify their identity. The cardholder may verify their identity by responding to the verification request by providing a piece of information that only they will know. In some embodiments, the cardholder may provide a secure PIN associated with the user. In some other embodiments, the cardholder may provide a PIN associated with the card or account being used in the current transaction. In both scenarios, the cardholder confirms their identity to the network 125.

Upon confirmation of the cardholder's identity and the cardholder's acceptance of the transaction details, network 125 proceeds to correlate cardholder's mobile phone number or other provided identity identifier to the actual payment card or account number of the payment card presented for payment purposes. The actual payment card or account number and transaction details are routed for authorization with issuer 130. The transaction authorization may then continue as is known in the art since the transaction data now includes the actual payment card or account number.

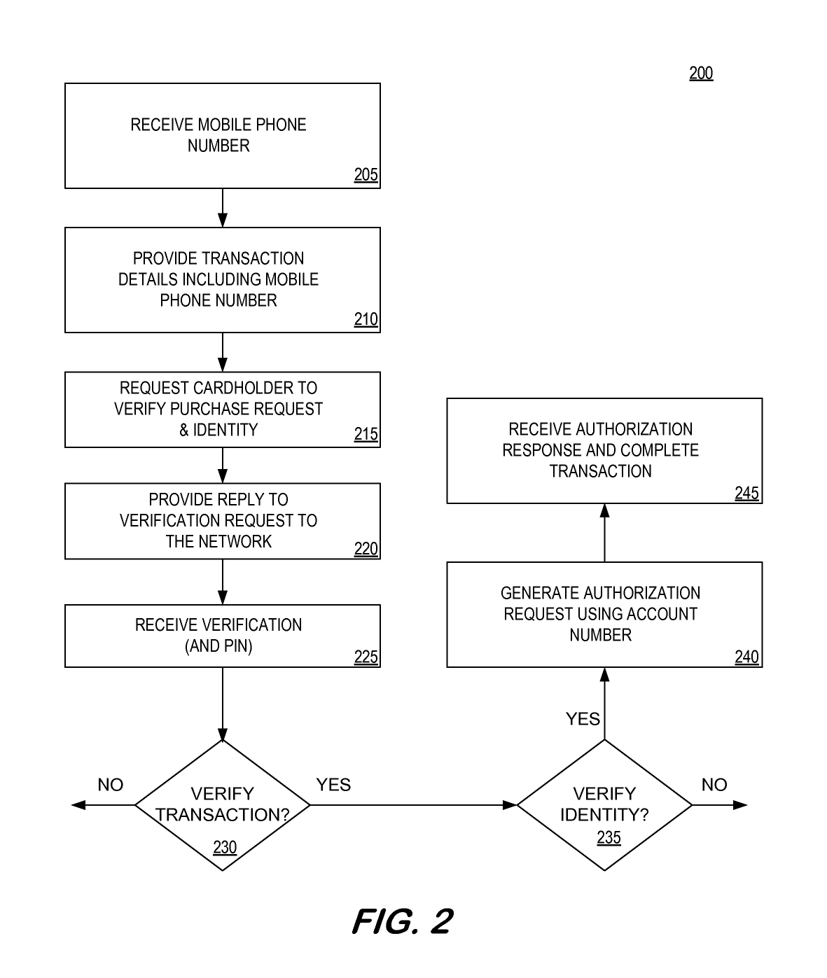

Reference is now made to the flow chart of FIG. 2 that illustrates a purchase transaction method that may be performed according to some embodiments. The flow chart in FIG. 2 and the other figures described herein do not imply a fixed order to the steps, and embodiments of the present invention can be practiced in any order that is practicable. Moreover, the methods may be performed by any one or more of the devices described herein or other devices. Each element of FIG. 2 might be performed by a different entity (e.g., by an issuer, a network processor, a merchant, or any other agent or party). Moreover, any single element might be performed by multiple parties.

Referring to process 200, an illustrative example is provided. According to some embodiments as shown, a cardholder is engaged in a purchase transaction with a merchant to make a purchase using a payment card or account. In contrast to some other purchase transactions, the user provides a unique and personal identifier instead of an account number to the merchant. The unique and personal identifier may comprise the mobile phone number assigned to a device owned by or otherwise associated with the cardholder. At 205, the merchant receives the mobile phone number or other identity identifier of the cardholder, as well as other transaction data needed to further process the purchase transaction. The unique and personal identifier may have been previously linked or otherwise associated with one or more payment cards and accounts of the cardholder. However, the merchant need not be aware of such as associations between the unique and personal identifier and the one or more payment cards and accounts.

As used herein, the payment card or account may be embodied on or in a credit card, debit card, reward card, charge card, stored value card, and other devices. In some respects, the payment device may include a proximity payment device, whether a standalone device or a device, apparatus, or system including functionality of the, for example, proximity payment device.

At operation 210 of process 200, transaction details including the mobile phone number of the cardholder and other transaction data such as the purchase amount, category of goods and services included in the transaction, the date of the transaction, and other information such as that related to the involved merchant and acquirer (or third party processor) is provided to the network 125. Not insignificantly, an actual account number (e.g., credit card number, debit card number, charge card number, prepaid card number, a demand deposit account number) is not provided at 210 since the merchant and/or the acquirer do not have access to or have been provided such information in the present purchase transaction. In some embodiments, the actual account number is provided neither in the clear nor encrypted to the merchant.

In some embodiments, an alias may be provided to the merchant so the merchant can tie a transaction to a specific payment account. In some embodiments, the alias is provided to the merchant and the merchant passes the supplied alias to network 125 along with the transaction details. The network may then use the provided information to associate the identity of the cardholder and the alias to a particular account in the cardholder's established Identity Payment service account. In some aspects, the alias may be provided in addition to the unique identity identifier to provide an indication of a particular payment card or other account to be used to complete the transaction. In one embodiment, the particular card to be used with an alias may be selected by the cardholder and associated with the account of their choosing. The user may select the alias from a set of standard labels such as, for example “credit card”, “debit card”, “checking account”, etc. In other instances, the cardholder may determine the alias label, such as, for example “Pam's card”, “business card”, “vacation card”, etc.

At 215, the cardholder is prompted or requested to verify the purchase transaction associated with their unique identity identifier (e.g., mobile phone number). In some embodiments, the cardholder is requested to verify or approve the various aspects of the transaction, including a transaction amount and for the goods and services included in the transaction data. Some of the details that may be provided to the cardholder by the network for review and verification may include line item details such as a purchase total, the pricing of individual goods and services, a purchase date, and any other data captured in a line item detailed receipt. The transaction data may be forwarded to the cardholder in a message formatted for receipt and review by the cardholder at their mobile phone or other device functionally configured to operate in accord with the present disclosure (e.g., text, email, multimedia messaging service message, instant message, and Short Message Service message), as a file formatted for viewing via the cardholder's mobile phone (e.g., a text based word processor compatible document), or other types of notifications (e.g., an smartphone application alert to view an application operating of the smart phone for the transaction details).

In some embodiments, line item details and other receipt information may be reviewed by the cardholder during the verification process, in an instance such details are available. In some embodiments, such detailed information that can be reviewed as part of the verification process may be available on or via a mobile application or service and may be made available in a hosted online environment for review any time. In some aspects, the transaction data may be made available via an application programming interface, API, or other mechanism that facilitates communication between devices, applications, and services. In one embodiment, the transaction data may be made available through a data feed to third parties such as merchants, issuers, etc. having proper security and privacy features in place. In some embodiments, line item transaction data may also be aggregated and made available via the API to a party or entity as a service, file transfer, online interface, etc.

In some embodiments, the transaction data may not itself be forwarded to the cardholder but may be viewable by the cardholder. For example, transaction data to be verified may be hosted by a web service and the cardholder may be invited or requested to view and either approve (or not) the purchase transaction. In some aspects, an application, service, or feature of a mobile phone or other device (e.g., netbook, tablet computer, etc.) associated with the mobile phone number or other identity identifier may be accessed or invoked to at least view the transaction data related to the purchase transaction.

In some embodiments, purchase verification and approval may be set to initiate at a threshold set by the user. In some instances, the network 125, a service provider, or issuer 130 may set a maximum transaction amount threshold that must be satisfied before authorization for the transaction is required. For example, the threshold for all payments over a total amount of $50 may require authorization.

In some embodiments, the cardholder may have an opportunity to change or alter the particular payment card or account associated with the purchase transaction provided at 210 for which verification is requested at 215. In some embodiments, the cardholder may select any one of the other payment cards or accounts previously linked to the cardholder's mobile phone number for an “identity payment”. For example, the cardholder may opt to associate the payment card with the alias “Special” with the current purchase transaction rather than the “default” payment card or account originally linked to the purchase transaction and mobile phone number.

Part of the verification process of 215 may include the cardholder verifying that they are the mobile phone number owner and thus the responsible owner of the payment card or account linked to the mobile phone number. Verification of the cardholder's identity may be provided by the cardholder providing a PIN that only they should know.

In some embodiments, a security feature may involve a secret code being generated (based on an algorithm and or other calculations) at the cardholder's mobile phone or other device associated with the cardholder's mobile phone number or other identity identifier. The thus generated secret code may be forwarded to network 125 or an appropriate third party processor or servicer for confirmation and verification of the cardholder's identity in addition to the PIN or other security features. As seen in FIG. 2, the verification data is provided to the network at 220.

While the cardholder may verify their identity and the transaction, the cardholder may likewise not approve the verification request. In an instance the cardholder disagrees with portions of the verification data presented for review and approval, the cardholder may halt the purchase transaction.

In some embodiments, the cardholder may report a problem, such as suspected or actual fraud, concerning their “identity”. The network may operate to assess fraud and other complaints and may even disable a merchant if it determines certain risk thresholds are exceeded.

At 225, the network (or network servicer) 125 receives a message or other indication of the cardholder's response to the cardholder and transaction verification request of 215 as provided at 220. If the cardholder approves the purchase transaction as indicated in the response received at 225 at decision point 225, then process 200 proceeds to operation 235. Operation 235 determines whether the cardholder verified their identity. If so, then process 200 continues to 240 for authorization of the purchase transaction using an actual payment card or other associated account number. If either the transaction approval at 230 or the identity verification at 235 is negative, then the process may terminate. In some instances, process 200 may retry the verification operations of 215-230 if either the transaction approval at 230 or the identity verification at 235 fails.

In some embodiments, the verification operations of 215-230 may fail or otherwise not be completed due to a communication link disconnect, delay (e.g., network latency), or error. In some embodiments where a communication link is not established in a timely matter to complete the transaction at a POS (either online or in person), an alternative mechanism for completing the transaction may be provided. In one embodiment, the cardholder attempting to make a purchase transaction using the Identify Payment service herein may provide a PIN at a POS terminal. The PIN provided in this manner, perhaps unsolicited due to the lack of a direct communication link between the cardholder's communication device (e.g., their mobile phone) and the network, may be provided with the cardholder's identity identifier to the network for verification by the network servicer. In some aspects, transactions completed in this manner may entail security procedures similar to a “debit PIN” purchase, including the feature of the PIN not being stored by the merchant or other entities.

If both the transaction approval at 230 and the identity verification at 235 are positive, process 200 continues to 240 for authorization of the purchase transaction using the actual payment card account number. The actual payment card or other designated account number may be obtained using a look up table or other data structure that correlates, links, or associates the cardholder's identity identifier (e.g., mobile phone number) and the one or more payment cards and accounts, as discussed herein. The mobile phone number or other identity identifier and the payment card being used for the purchase transaction may be used to look up the actual account number. At 245, a response to the authorization request of operation 240 is received. In some embodiments, the authorization of operations 240 and 245 may proceed in a known manner since the account number is now utilized in the transaction processing. In some embodiments, the authorization may proceed through a payment network (such as a bank payment network, e.g., the MasterCard BankNet network or the like) to obtain authorization.

In some embodiments, processing of a transaction with an issuer may include not providing an actual payment card or account number to the issuer. In some embodiments, transaction processing with the issuer may include converting an actual account number to a virtual card number (VCN) using a highly secure algorithm that may include the issuer's private key and an “RSA” or other algorithm prior to sending the account number to the issuer/issuer processor 130 from network 125.

In some embodiments, network 125 may provide a service, functionality, portal, application, or software to issuer 130 (or an entity on the issuer's behalf) that converts the VCN to an real card number (RCN) using the secure algorithm described above. The issuer may convert the VCN to an RCN, process the transaction related request, and return the VCN in a message to network 315. The processing of a transaction with an issuer may be applied to a variety of account types, including accounts associated with a demand deposit account, a rewards card/account, a credit card account, a debit card account, a stored value card account, a charge card account, and other types of accounts. In some embodiments including the use of a VCN for processing transactions with an issuer, the process of enrolling an account into an Identity Payment service (or electronic wallet feature/service) may include the issuer providing the VCN and issuer key (e.g., ICA).

In some embodiments, a third party processor (not shown in FIG. 1) may be located between network 125 and issuer 130 for processing transactions with the issuer. In some instances including this third party processor, the actual payment card or other associated account number may not be provided to the third party processor. Instead, an encrypted payment card account number may be provided to the third party processor from network 125 and from the third party processor to issuer 130. Upon receipt of the encrypted payment card account number from the third party processor, the issuer may decrypt it for processing.

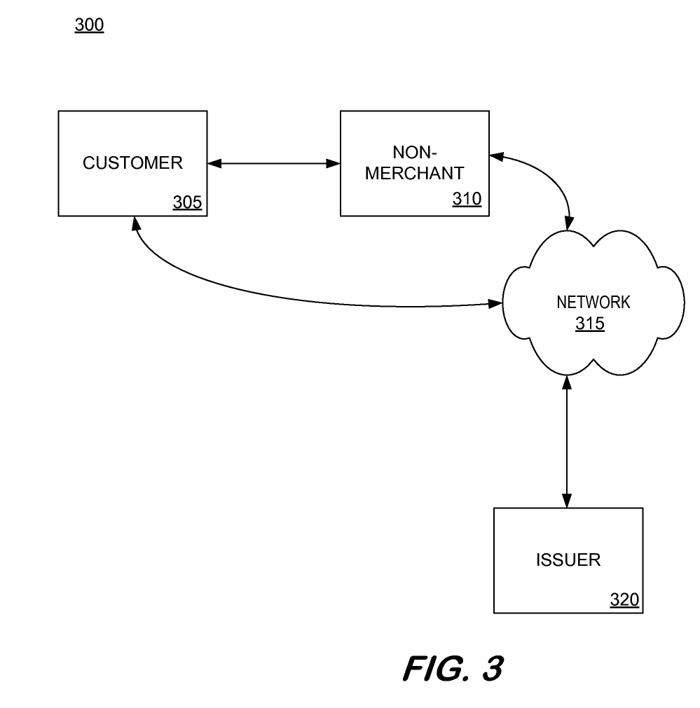

FIG. 3 is a system 300 diagram illustrative of a context where a purchase transaction does not involve a merchant having a merchant account as supported by, for example, an acquirer. System 300 does not include a merchant as included in FIG. 1. As such, a person 305 may wish to pay “non-merchant” person 310 using a unique and personal identifier and avoid giving person 310 their payment card or account number. In this scenario, person 310 may be identified by their own mobile phone number or other identity identifier that is registered with an “Identity Payment” service.

Other aspects of system 300 may operate similar to those similar components in FIG. 1, including network 315 and issuer 325. As such, a detailed discussion of FIG. 3 is not provided here since FIG. 1 is discussed in detail hereinabove.

In some embodiments, a third party processor (not shown in FIG. 3) may be located between network 315 and issuer 320 for processing transactions with the issuer. In some such embodiments, the actual payment card or other associated account number may not be provided to the third party processor. Instead, an encrypted payment card account number may be provided to the third party processor from network 315 and from the third party processor to issuer 320. Issuer 320 may decrypt the encrypted payment card account number for processing thereof.

Accordingly, it is seen that aspects herein may be extended to use cases not strictly involving merchants.

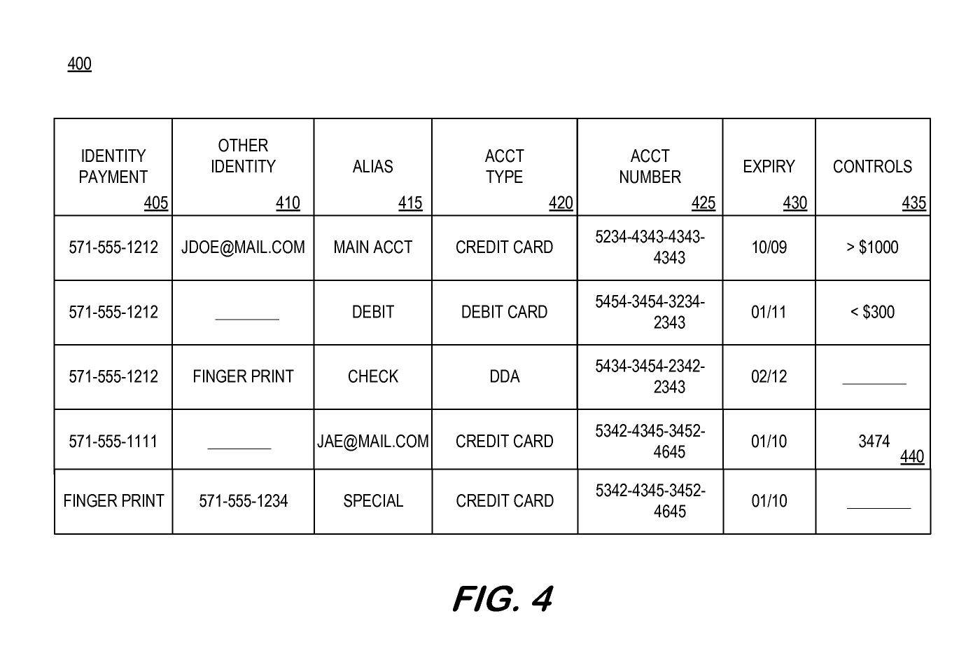

Reference is now made to FIG. 4, which is a portion of a tabular representation of an Identity Payment database record 400 that may be stored at (or accessible to) the network 125 according to some embodiments of the present disclosure. The table included in FIG. 4 includes entries identifying individual unique and personal identifiers that may be accessed and used in payment transactions pursuant to embodiments herein. Table 400 defines fields 405-435 for each “identity” entry. The fields specify an Identity Payment identifier 405 (the mobile phone number, in some embodiments, that may be used to uniquely identify individual cardholders of the present invention), an other identifier 410 field (e.g., an email account, an IM service screen name, biometric data, etc.), an alias 415 (used, in some embodiments, to provide a convenient and recognizable name to reference the various cards and accounts associated with the cardholder's mobile phone number), an account type 420, one or more account numbers 425 (which are each payment card account identifiers associated with an actual payment card associated with the user of the Identity Payment service identified by the identity payment identifier 405, other identifier, and alias), one or more account number expiry dates 430 (which are the expiration dates, if any, associated with each of the payment cards and accounts), and control parameters 435 (such as, for example, use triggers, parameters, and conditions selectively associated with the accounts based on user preferences that may indicate the conditions the account may be used or prohibited from being used (e.g., above or below a specified dollar amount).

In some embodiments, the network or network servicer may operate to associate or correlate an identity 405 with an account 425, associate or correlate an alternative identifier 410 with an account 425, and associate or correlate an alias 415 with an account 425, and any combinations thereof. In some embodiments, an identity payment transaction may not include values for each of fields 405, 410, and 415. However, the network may include functionality to provide the requisite reconciling of the provided identity information with the appropriate account number(s). The network may include the functionality to provide the mapping between the user supplied identity identifiers and the associated account(s).

In some embodiments, the values used for identity payment identifier 405, other identifier 410, and alias 415 may be selected from, for example, a mobile phone number; a land line phone number; a uniquely generated/assigned string of alpha-numeric characters and/or symbols; an audio, graphic, video, or other type of file; a bioidentity identifier; an email, instant messaging, social network, or other type of identifier/username, and other values. In general, the type of entries and the particular values for identity payment identifier 405, other identifier 410, and alias 415 may be governed by a rule(s). Moreover, a general constraint for the type of entries and the particular values for identity payment identifier 405 may include the identity payment being a unique identifier.

In some embodiments, control parameters 435 may include triggers, parameters, and conditions selectively associated with the accounts based on user preferences to indicate the conditions governing when the account may be used as payment for a transaction. For example, a particular account number specified in column 425 may, depending on the value of the associated control parameter in column 435, be used for transactions of a minimum dollar amount, for transactions less than a maximum dollar amount, for particular types of goods and services (e.g., as specified by, for example, a merchant category code, MCC), for a set time period (e.g., a range of dates), other limitations and combinations thereof. Thus, a combination of controls may be associated with a particular account. In the example of FIG. 4, an MCC code of “3474” indicative of groceries is shown at 440.

The information in the Identity Payment database record 400 may be created, for example, when a cardholder uses features of the present invention to make a purchase transaction. In some embodiments, the information in the Identity Payment 400 may be created during an enrollment or registration process by a cardholder, and subsequent updates to accounts by cardholder. In some embodiments, the information in the Identity Payment database 400 is created prior to a transaction. Those skilled in the art will appreciate that other data fields and values may also be included in the Identity Payment database 400. For example, the Identity Payment database 400 may include cardholder background information (such as name, address, and birth year, demographics, etc.), as well as additional security or profile information. Furthermore, the identity payment data may be created and stored in any data structure or construct now known or that becomes known in the future.

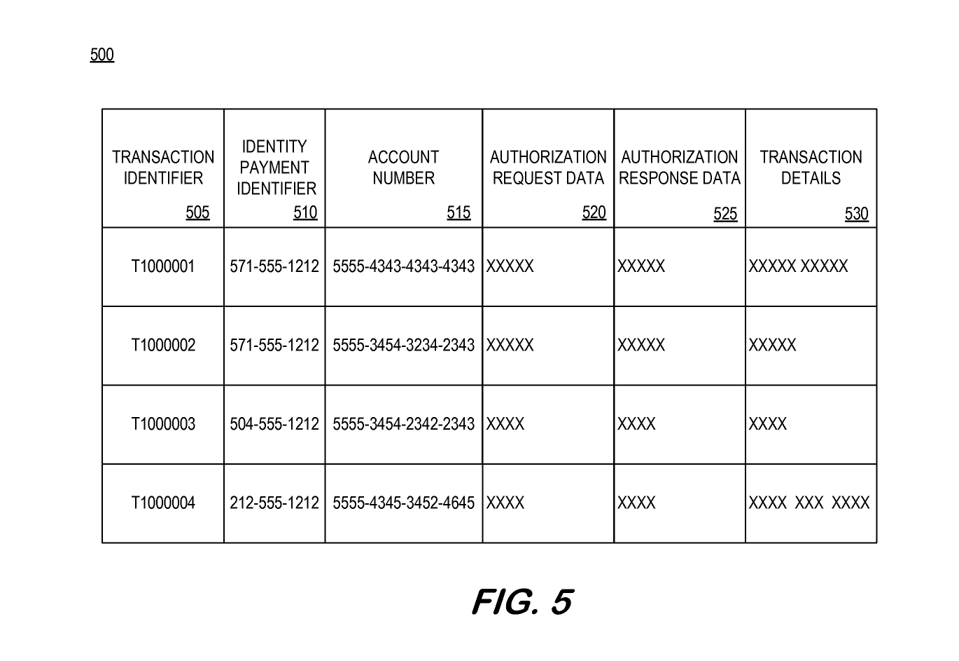

Referring now to FIG. 5 that includes a portion of a tabular representation of a transaction database 500 that may be stored at (or accessible to) network 125 according to some embodiments herein. The table of FIG. 5 includes entries identifying individual transactions that are being processed (or that have been processed) pursuant to the present invention. Table 500 defines fields 505-530 for each entry. The fields specify a transaction identifier 505 (used to uniquely identify individual electronic Identity Payment transactions that are being processed or that have been processed pursuant to embodiments herein), a Identity Payment identifier 510 (corresponding to a Identity Payment identifier 405, other identifier 410, or alias 415 of FIG. 4, and used to associate transaction data with a particular identity or mobile phone number), an account number 515 (representing the actual payment account number(s) linked or associated with the mobile phone number 510 and optional alias), authorization request data 520 (including the authorization request data (e.g., mobile phone number) from an authorization request message received from a merchant), and authorization response data 525 (including the authorization response received from the issuer associated with the account number 515 such as an approval code and other record tracking mechanisms. Also included in the example table of FIG. 5 is a transaction detail field 520. This field may include the line item details associated with the transaction, including but not limited to goods/services prices, descriptions, category of those goods/services, savings, etc. for each item, the purchase location, date, and merchant, and demographic information related to the purchaser and/or merchant.

The information in the transaction database 500 may be created, for example, during the course of a transaction pursuant to the present invention. Moreover, the database may be implemented in accordance with one or more database services, servers, and protocols.

Those skilled in the art will appreciate that other data fields and values may also be included in the transaction database 500. For example, the transaction database 500 may also include a merchant URL or posting instructions describing where (and how) the payment provider 120 should post or submit the updated authorization response message back to the merchant upon receipt.

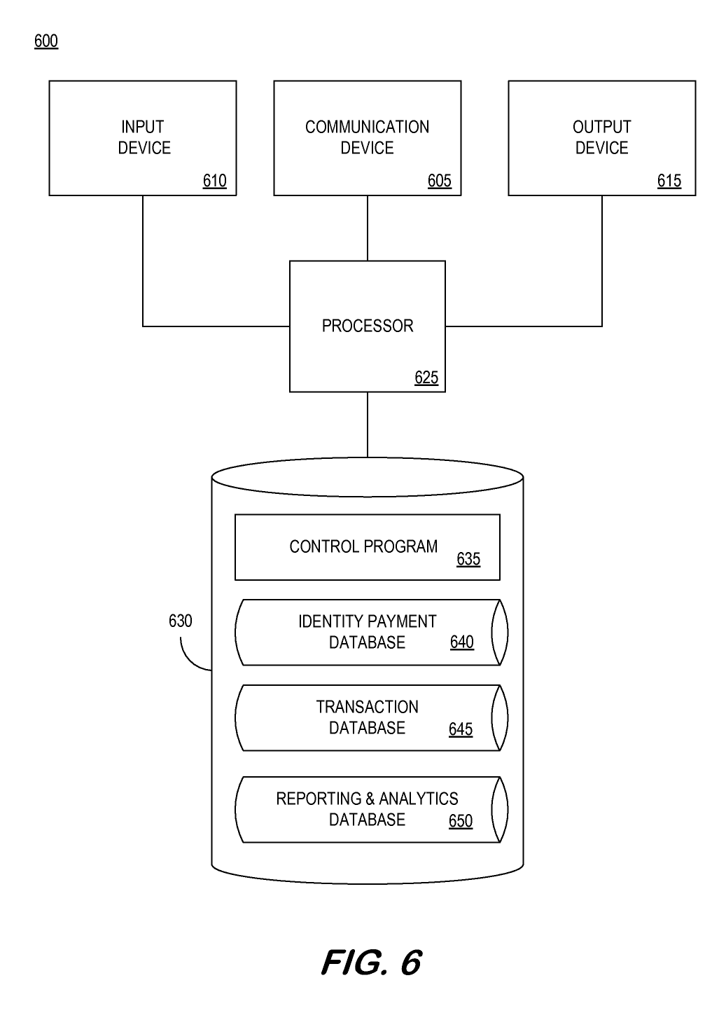

FIG. 6 is a block diagram of an apparatus 600 that may be descriptive of any of the devices (e.g., 110, 115, 120, 130) shown in FIG. 1, according to an embodiment herein. In some aspects, apparatus 600 may be configured and used to implement functions of network 125 as disclosed herein, including functionality to implement the methods, processes, and operations disclosed. Apparatus 600 may comprise aspects of an application, service, software as a service, server, web application server, or the like. In some aspects, apparatus 600 comprises a communication device 605 that may be used to communicate with other devices and entities such as customer 105, merchant 110, acquirer 115, and issuer 130. Apparatus 600 may also include an input device that may comprise a computing input device such as a keyboard, a mouse, a touchscreen, a microphone for text input, and any other types of input devices. Apparatus 600 also includes an output device 615. Output device 615 may be a mobile phone, monitor or other display output, a printer, or any other output devices such as reporting and/or messaging and notification mechanisms, including messaging and notification services.

Processor 625 may include one or more processors, cores, or CPU complexes. Processor 625, as shown, also interfaces with local input device 610 and local output device 615. The local input and output devices may facilitate the configuring of apparatus 600 and the generation of, for example reports and analytics data.

Processor 625 is shown in communication with a storage device 630. Storage device 630 may comprise any appropriate information storage device, including combinations of magnetic storage devices (e.g., magnetic tape and hard disk drives), optical storage devices, and/or semiconductor memory devices such as flash memory, Random Access Memory (RAM) and Read Only Memory (ROM), including local, remote, and distributed memory devices and systems.

As configured in FIG. 6, storage device 630 stores a control program 635 that functions to control processor 625. Control program 635 may be stored in a compressed, uncompiled and/or encrypted format, without limit to the data structures used therein. In some aspects, program 635 may include other program elements not particularly illustrated, such as an operating system, a database management system, and/or device drivers used by processor 625 to interface with, for example, input and output devices 610 and 615. Processor 625 operates to perform instructions of control program 635 stored in memory device 630, in accordance with the present disclosure. As an example, processor 625 may operate to perform at least some aspects of the process of FIG. 4, discussed hereinabove.

As used herein, information may be “received” by or “transmitted” to, for example apparatus 600 from a remote device, application, or service, or a software application or module within the apparatus 600 from another software application, module, or any other source.

Storage device 630 also stores an identity payment database 640 that includes records linking unique personal user identity identifiers (e.g., mobile phone number) and payment card or other account numbers, and a transaction database 645 that contains data concerning account balances and records of transactions performed with respect to the payment card and other accounts discussed herein and associated with “identities”.

Reporting and Analytics database 650 may include data and a mechanism or facilitate the collecting, analysis, generating, and reporting of reports and analytics related to an Identity Payment transaction herein. Reporting and Analytics database 650 may include information and data such as transaction mining data details, including goods, services, and merchant categories, item level details, and product SKU's, and demographic information. Reports generated and facilitated by database 650 may be provided in response to queries concerning geographic and other demographic criteria. In some aspects, the reports and data of database 650 may be packaged (in an aggregate manner to respect privacy procedures and policies) and offered to various entities (not shown) such as stores, issuers, research and reporting entities, demographic data analysis companies, etc. The output reports and data may provide a source of revenue for network 125 or other entities.

The databases of FIG. 6 are described, in some aspects, in detail with respect to FIG. 4 and FIG. 5, respectively.

Those skilled in the art will appreciate that other data items may also be stored or accessible using the apparatus, and that the above data items are shown for illustrating features of some embodiments of the present invention.

Although the present invention has been described in connection with specific exemplary embodiments, it should be understood that various changes, substitutions, and alterations apparent to those skilled in the art can be made to the disclosed embodiments without departing from the spirit and scope of the invention as set forth in the appended claims.

What is claimed is:

1. A method comprising:
receiving, during a purchase transaction, transaction data and a unique user identity identifier associated with a payment card;
providing the identity identifier and the transaction data to a payment network;
requesting verification of the transaction data and identity identifier;
receiving a reply to the verification request of the transaction data and the identity identifier;
associating a payment account number with the identity identifier; and
authorizing the purchase transaction based on the payment account number associated with the identity identifier.

2. The method of claim 1, wherein the identity identifier is a unique mobile phone number.

3. The method of claim 1, wherein the transaction data includes at least one of a transaction amount, a transaction date, a goods and services category, and line item transaction detail.

4. The method of claim 1, wherein the payment card is one of a credit card, a debit card, a prepaid card, a gift card, and a demand deposit account.

5. The method of claim 1, wherein receiving identity identifier associated with a payment card and transaction data does not include receiving an account number of the payment card.

6. The method of claim 1, further comprising an alias indicative of an account to associate with the purchase transaction

7. The method of claim 2, wherein the verification request comprises:
contacting a device associated with a mobile phone number assigned to an identity; and
receiving a reply to the verification request from the device.

8. The method of claim 1, wherein the receiving of a reply to the verification request further comprises receiving a personal identification number (PIN).

9. The method of claim 1, further comprising determining the account number based on the identity identifier.

10. The method claim 1, further comprising establishing an identity payment account and a set of rules to govern the operation of the identity payment account.

11. A system, comprising
a processor; and
a storage device in communication with the processor and storing instructions adapted to be executed by the processor, the processor operative with the instructions to:
receive, during a purchase transaction, transaction data and a unique identity identifier associated with a payment card;
provide the identity identifier and the transaction data to a payment network;
request verification of the transaction data and the identity identifier;
receive a reply to the verification request of the transaction data and the identity identifier; and
associate a payment account number with the identity identifier; and
authorize the purchase transaction based on the payment account number associated with the identity identifier.

12. The system of claim 10, wherein the identity identifier is a unique mobile phone number.

13. The system of claim 10, wherein the transaction data includes at least one of a transaction amount, a transaction date, a goods and services category, and line item transaction detail.

14. The system of claim 10, wherein the payment card is one of a credit card, a debit card, a prepaid card, a gift card, and a demand deposit account.

15. The system of claim 10, wherein to receive the identity identifier associated with a payment card and transaction data does not include receiving the account number of the payment card.

16. The system of claim 12, wherein the verification request comprises instructions to:
contact a device associated with a mobile phone number assigned to an identity; and
receive a reply to the verification request from the device.

17. The system of claim 11, wherein the processor is operative with the instructions to further receive a personal identification number (PIN) with the reply to the verification request.

18. The system of claim 11, wherein the processor is operative with the instructions to further determine the account number based on the identity identifier.

19. The system of claim 11, wherein the processor is operative with the instructions to further establish an identity payment account and a set of rules to govern the operation of the identity payment account.
